(19) United States
(12) Patent Application Publication
(10) Pub. No.: US 2026/0113078 A1
(43) Pub. Date: Apr. 23, 2026

(54) HIGH FREQUENCY WIRELESS LOCAL AREA NETWORK SYSTEM INCLUDING RECONFIGURABLE INTELLIGENT SURFACE AND OPERATING METHOD THEREOF

(71) Applicant: ELECTRONICS AND TELECOMMUNICATIONS RESEARCH INSTITUTE, Daejeon (KR)

(72) Inventors: Jinhyung OH, Daejeon (KR); Myung Don KIM, Daejeon (KR); Jong Ho KIM, Daejeon (KR)

(73) Assignee: ELECTRONICS AND TELECOMMUNICATIONS RESEARCH INSTITUTE, Daejeon (KR)

(21) Appl. No.: 19/364,639

(22) Filed: Oct. 21, 2025

(30) Foreign Application Priority Data
Oct. 22, 2024 (KR) 10-2024-0145173

(51) Int. Cl. H04B 7/04; H04W 74/0816; H04W 84/12

(52) U.S. Cl. CPC H04B 7/04013; H04W 74/0816; H04W 84/12

(57) ABSTRACT

A wireless network system comprises a transmitter, a plurality of receivers, and a reconfigurable intelligent surface configured to relay communication between the transmitter and the plurality of receivers. The transmitter transmits an RTS frame to each of the plurality of the receivers through the reconfigurable intelligent surface. At least two receivers of the plurality of receivers respectively transmit a CTS frame to the transmitter through the reconfigurable intelligent surface in response to the RTS frame. The transmitter is configured to transmit a plurality of data frames simultaneously to the at least two receivers that transmitted the CTS frame, respectively, through the reconfigurable intelligent surface.

### CROSS-REFERENCE TO RELATED APPLICATIONS

This application claims priority under 35 U.S.C. § 119 to Korean Patent Application No. 10-2024-0145173 filed on Oct. 22, 2024, in the Korean Intellectual Property Office, the disclosure of which is incorporated by reference herein in its entirety.

### BACKGROUND

The present disclosure relates to high frequency wireless local area network systems and operating methods thereof, and more particularly, relates to high frequency wireless network systems and operating methods thereof including a reconfigurable intelligent surface.

Referring to specifications described in IEEE 802.11 standard, a frequency band for performing communication in a wireless local area network (WLAN) is concentrated in a low frequency band such as 2.4 GHz, 5 GHz, 6 GHz, and/or etc. It is assumed that a direct path exists between a transmitter and a receiver for performing wireless communication in the low frequency band.

In a next-generation wireless local area network, it is necessary to use a high frequency band in order to rapidly increase a channel capacity. However, when the high frequency band is used, there is a problem that reliability of data transmission is reduced because the direct path does not exist between the transmitter and the receiver as a wavelength of a radio wave is short, signal intensity is attenuated, straightness of the radio wave is strong, and a radio wave loss due to an obstacle increases.

In addition, along with the channel capacity, the number of devices that connect to a channel at the same time is also increasing. In this case, when the transmitter transmits data to a plurality of receivers, there is a problem that signal interference occurs and a data transmission rate reduces due to a restriction of the channel capacity.

### SUMMARY

The object of the present disclosure is to provide a high frequency wireless local area network system and an operating method thereof, having improved data reliability and data transmission rate.

A wireless network system according to an embodiment of the present disclosure comprises a transmitter, a plurality of receivers, and a reconfigurable intelligent surface configured to relay communications between the transmitter and the plurality of receivers; wherein the transmitter transmits an RTS frame to each of the plurality of receivers through the reconfigurable intelligent surface, wherein at least two receivers of the plurality of receivers respectively transmit a CTS frame to the transmitter through the reconfigurable intelligent surface in response to the RTS frame, and wherein the transmitter is configured to transmit a plurality of data frames simultaneously to the at least two receivers that transmitted the CTS frame, respectively, through the reconfigurable intelligent surface.

In an embodiment, each of the RTS frame and the CTS frame comprises a field related to information of time required for the reconfigurable intelligent surface to relay communication between the transmitter and the plurality of receivers.

In an embodiment, when there is at least one receiver of the plurality of receivers that did not transmit a CTS frame to the transmitter through the reconfigurable intelligent surface in response to the RTS frame, the at least one receiver is configured to set a NAV based on the field related to the information of the time.

In an embodiment, the transmitter is configured to combine the plurality of data frames to be transmitted simultaneously to the at least two receivers into one multiple access frame.

In an embodiment, the transmitter is configured to transmit the one multiple access frame to the reconfigurable intelligent surface.

In an embodiment, the reconfigurable intelligent surface is configured to separate the received one multiple access frame into the plurality of data frames.

In an embodiment, the wireless network system further comprises a controller configured to control a reflection coefficient of the reconfigurable intelligent surface, wherein the controller is configured to receive the RTS frame from the transmitter, receive the CTS frame from each of the at least two receivers, generate a control signal based on the received RTS frame and the received CTS frame, and transmit the control signal to the reconfigurable intelligent surface.

In an embodiment, the reconfigurable intelligent surface is configured to set the reflection coefficient based on the control signal, and transmit the plurality of data frames simultaneously to the at least two receivers, respectively, based on the reflection coefficient.

An operating method of a wireless network system according to an embodiment of the present disclosure comprises transmitting, by a transmitter, an RTS frame to each of a plurality of receivers through a reconfigurable intelligent surface, respectively transmitting, by at least two receivers of the plurality of receivers, a CTS frame to the transmitter through the reconfigurable intelligent surface in response to the RTS frame, and transmitting, by the transmitter, a plurality of data frames simultaneously to the at least two receivers that transmitted the CTS frame, respectively.

In an embodiment, the operating method further comprises setting, by at least one receiver that did not transmit a CTS frame to the transmitter, a NAV based on a field related to information of time required for communication through the reconfigurable intelligent surface between the transmitter and the plurality of receivers, the field included in the RTS frame and the CTS frame.

In an embodiment, the transmitting the plurality of data frames simultaneously comprises combining, by the transmitter, the plurality of data frames to be respectively transmitted to the at least two receivers into one multiple access frame, and transmitting, by the transmitter, the one multiple access frame to the reconfigurable intelligent surface.

In an embodiment, the transmitting the plurality of data frames simultaneously further comprises: separating, by the reconfigurable intelligent surface, the one multiple access frame into the plurality of data frames, and transmitting, by the reconfigurable intelligent surface, the plurality of data frames simultaneously to the at least two receivers, respectively.

In an embodiment, the operating method further comprises receiving, by a controller, the RTS frame from the transmitter, receiving, by the controller, the CTS frames from each of the at least two receivers, generating, by the controller, a control signal based on the RTS frame and the CTS frame, and transmitting, by the controller, the control signal to the reconfigurable intelligent surface.

In an embodiment, the operating method further comprises setting, by the reconfigurable intelligent surface, a reflection coefficient based on the control signal.

In an embodiment, the transmitting, by the reconfigurable intelligent surface, the plurality of data frames simultaneously to the at least two receivers, respectively, further comprises transmitting, by the reconfigurable intelligent surface, the plurality of data frames simultaneously to the at last two receivers, respectively, based on the reflection coefficient.

A high frequency wireless local area network system according to an embodiment of the present disclosure comprises a transmitter, a plurality of receivers, a reconfigurable intelligent surface configured to relay communication between the transmitter and the plurality of receivers and a controller configured to control a reflection coefficient of the reconfigurable intelligent surface, wherein the plurality of the receivers respectively transmit a CTS frame to the transmitter through the reconfigurable intelligent surface in response to an RTS frame that the transmitter transmits to each of the plurality of the receivers through the reconfigurable intelligent surface, wherein the controller generates a control signal based on the RTS frame received from the transmitter and the CTS frame transmitted by the plurality of receivers in response to the RTS frame, and transmits the generated control signal to the reconfigurable intelligent surface, and wherein the transmitter combines a plurality of data frames to be respectively transmitted to the plurality of receivers that transmitted the CTS frame through the reconfigurable intelligent surface into one multiple access frame, and transmits the one multiple access frame to the reconfigurable intelligent surface, and wherein the reconfigurable intelligent surface is configured to separate the one multiple access frame into the plurality of data frames, set the reflection coefficient based on the control signal, and transmit the plurality of data frames to the plurality of receivers that transmitted the CTS frame, respectively, based on the reflection coefficient.

### BRIEF DESCRIPTION OF THE FIGURES

The above and other objects and features of the present disclosure will become apparent by describing in detail embodiments thereof with reference to the accompanying drawings.

FIG. 1 is a diagram illustrating a wireless network system according to an embodiment of the present disclosure.

FIG. 2 is a diagram illustrating an example of an operating method of a wireless network system according to an embodiment of the present disclosure.

FIG. 3 is a diagram illustrating an example of a method for recruiting nodes to transmit the data frames by a wireless network system according to an embodiment of the present disclosure.

FIG. 4 is a diagram illustrating an example of a method for setting a reflection coefficient of a reconfigurable intelligent surface by a wireless network system according to an embodiment of the present disclosure.

FIG. 5 is a diagram illustrating an example of a method for simultaneously transmitting data frames by a wireless network system according to an embodiment of the present disclosure.

FIG. 6 is a diagram illustrating an example of an operation of a protocol of a wireless network system according to an embodiment of the present disclosure.

FIGS. 7A and 7B are diagrams illustrating an RTS frame and a CTS frame of a wireless network system according to an embodiment of the present disclosure.

FIG. 8 is a diagram illustrating a frame control field included in the RTS frame and the CTS frame of FIGS. 7A and 7B.

### DETAILED DESCRIPTION

Hereinafter, embodiments of the present invention will be described clearly and in detail to such an extent that ordinary one in the art easily implements the present disclosure.

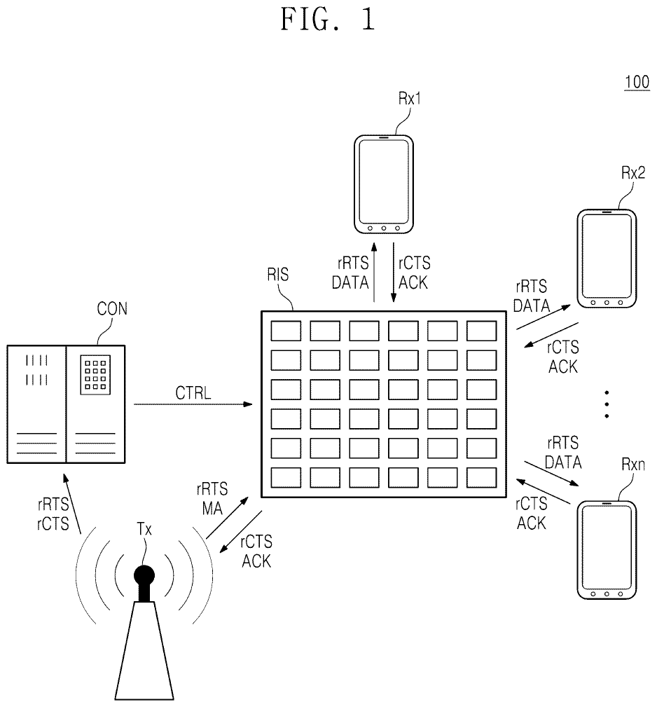

FIG. 1 is a diagram illustrating a wireless network system according to an embodiment of the present disclosure. Referring to FIG. 1, a wireless network system 100 may include a transmitter Tx, a plurality of receivers Rx1 to Rxn, a reconfigurable intelligent surface RIS, and a controller CON.

The transmitter Tx and the plurality of receivers Rx1 to Rxn may exchange a request to send (RTS) frame rRTS and a clear to send (CTS) frame rCTS in order to recruit nodes (e.g., the transmitter Tx and/or the receiver Rx) to be accessed to the wireless channel. For example, as the transmitter Tx transmits the RTS frame IRTS to the plurality of receivers Rx1 to Rxn, each of the receivers having a data frames DATA to be received from the transmitter Tx through the wireless channel among the plurality of receivers Rx1 to Rxn may transmit the CTS frame rCTS to the transmitter Tx. Hereinafter, an operation in which the transmitter Tx and a plurality of receivers Rx1 to Rxn connect to the wireless channel and perform communication based on a result of exchanging the RTS frame rRTS and the CTS frame rCTS as described above will be described in detail.

The transmitter Tx may transmit the RTS frame rRTS to each of the plurality of receivers Rx1 to Rxn. For example, the transmitter Tx may connect to a wireless channel and transmit the RTS frame rRTS to each of the receivers Rx1 to Rxn. The transmitter Tx may transmit the data frames DATA simultaneously to at least some of the receivers Rx1 to Rxn, respectively, based on the RTS frame rRTS transmitted to the receivers Rx1 to Rxn, respectively.

Each of the plurality of receivers Rx1 to Rxn may receive the RTS frame rRTS from the transmitter Tx. Hereinafter, the receivers having the data frames DATA to be received from the transmitter TX through the wireless channel among the plurality of the receivers Rx1 to Rxn that received the RTS frame rRTS from the transmitter Tx are referred to as access receivers. In addition, the remaining receivers having no data frame DATA to be received from the transmitter Tx through the wireless channel (e.g., receivers that overheard the RTS frame rRTS) among the plurality of receivers Rx1 to Rxn that received the RTS frame rRTS from the transmitter Tx are referred to as non-access receivers.

Each of the access receivers may transmit the CTS frame rCTS to the transmitter Tx in response to the RTS frame rRTS. For example, the number of the access receivers may be at least two or more. In this case, each of the access receivers that transmitted the CTS frame rCTS to the transmitter Tx may receive the data frames DATA simultaneously from the transmitter Tx through the wireless channel. Each of the access receivers that received the data frames DATA simultaneously from the transmitter Tx may transmit an acknowledgement frame ACK to the transmitter Tx.

On the other hand, the number of the non-access receivers may be at least one or more, or there may be no non-access receivers. For example, when the plurality of receivers Rx1 to Rxn are all access receivers having the data frames DATA to be received from the transmitter Tx, there may be no non-access receivers. When there is at least one non-access receiver, each of the non-access receivers may not transmit the CTS frame rCTS to the transmitter Tx in response to the RTS frame rRTS. In this case, each of the non-access receivers that did not transmit the CTS frame rCTS to the transmitter Tx may set a Network Allocation Vector (NAV) based on the RTS frame rRTS received from the transmitter Tx and the CTS frame rCTS transmitted by each of the access receivers to the transmitter Tx.

The NAV may indicate a time during which any node uses a wireless channel in the wireless network system 100 according to an embodiment of the present disclosure. For example, each of the non-access receivers may set a time during which the transmitter Tx uses the wireless channel as the NAV based on the RTS frame rRTS received from the transmitter Tx, and each of the access receivers may set a time during which each of the access receivers uses the wireless channel as the NAV based on the CTS frame rCTS transmitted to the transmitter Tx.

The reconfigurable intelligent surface RIS may relay communication between the transmitter Tx and each of the plurality of receivers Rx1 to Rxn. For example, the reconfigurable intelligent surface RIS may include a plurality of reflective elements. When transmitting a signal received from the transmitter Tx to each of the plurality of receivers Rx1 to Rxn and transmitting a signal received from each of the plurality of receivers Rx1 to Rxn to the transmitter Tx, the plurality of reflective elements may transmit the signal in an optimized path or a strong path by controlling a phase and/or an amplitude of the signal, and improve reliability of data included in the signal. For example, based on the control of the plurality of reflective elements, the reconfigurable intelligent surface RIS may transmit the RTS frame rRTS received from the transmitter Tx to each of the plurality of receivers Rx1 to Rxn, transmit the CTS frame rCTS received from each of the access receivers to the transmitter Tx, simultaneously transmit the data frames DATA received from the transmitter Tx to each of the access receivers, and transmit the acknowledgement frame ACK received from each of the access receivers to the transmitter Tx.

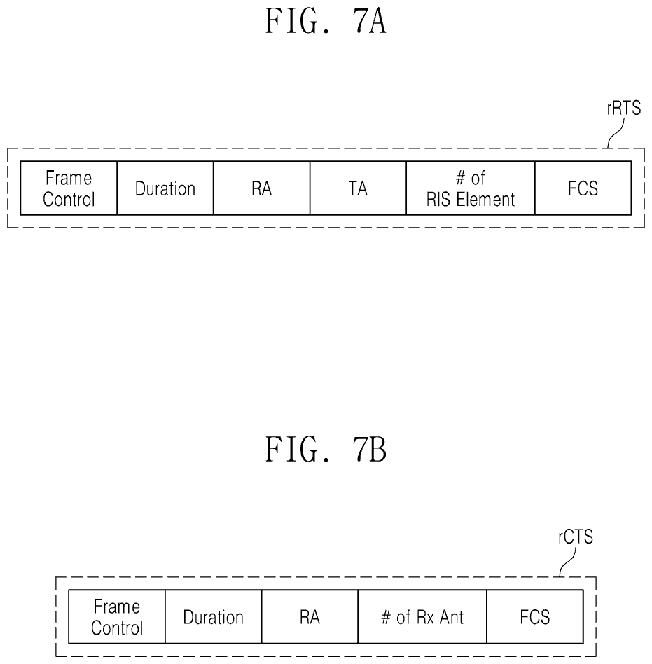

In the wireless network system 100 according to the embodiment of the present disclosure, each of the RTS frame rRTS and the CTS frame rCTS exchanged by the transmitter Tx and each of the plurality of receivers Rx1 to Rxn may include a field indicating whether the corresponding frame is exchanged through the reconfigurable intelligent surface RIS (e.g., a frame control field). Therefore, each of the transmitter Tx and the plurality of receivers Rx1 to Rxn exchanging the RTS frame rRTS and the CTS frame rCTS may determine whether the corresponding frame is the frame relayed by the reconfigurable intelligent surface RIS or not based on the field of the corresponding frame. A description of the field indicating whether the corresponding frame is exchanged through the reconfigurable intelligent surface RIS will be described below with reference to FIGS. 7A and 7B.

The controller CON may control a reflection coefficient of the reconfigurable intelligent surface RIS. The controller CON may generate a control signal CTRL based on the RTS frame rRTS transmitted by the transmitter Tx to each of the plurality of receivers Rx1 to Rxn and the CTS frame rCTS transmitted by each of the access receivers to the transmitter Tx. For example, the controller CON may receive the RTS frames rRTS transmitted by the transmitter Tx to each of the receivers Rx1 to Rxn and CTS frames rCTS transmitted by the access receivers to the transmitter Tx from the transmitter Tx. The controller CON may transmit the generated control signal CTRL to the reconfigurable intelligent surface RIS.

The reconfigurable intelligent surface RIS may set the reflection coefficient based on the control signal CTRL. The reconfigurable intelligent surface RIS may transmit the data frames DATA simultaneously to each of the access receivers based on the set reflection coefficient. For example, each of the plurality of reflective elements of the reconfigurable intelligent surface RIS may control the phase and/or amplitude of the signal including each of the data frames DATA based on the set reflective coefficient. Accordingly, the data frames with improved reliability DATA may be transmitted simultaneously to each of the access receivers.

In the wireless network system 100 according to the embodiment of the present disclosure, when there is an obstacle between the transmitter Tx and each of the plurality of receivers Rx1 to Rxn (e.g., when there is no direct path), each of the receivers Rx1 to Rxn may decode each of the RTS frame rRTS and the data frames DATA received from the transmitter Tx through the reconfigurable intelligent surface RIS. On the other hand, when there is no obstacle between the transmitter Tx and each of the plurality of receivers RX1 to Rxn (e.g., when there is direct path), each of the plurality of receivers Rx1 to Rxn may synthesize and decode each of the RTS frame IRTS and the data frame DATA received directly from the transmitter TX and each of the RTS frame rRTS and the data frame DATA received from the transmitter TX through the reconfigurable intelligent surface RIS, respectively.

In the wireless network system 100 according to an embodiment of the present disclosure, as described above, as the reconfigurable intelligent surface RIS relays communication between the transmitter Tx and the plurality of receivers Rx1 to Rxn, the data reliability may be improved.

In the wireless network system 100 according to the embodiment of the present disclosure, when the transmitter Tx transmits the data frames DATA simultaneously to the reconfigurable intelligent surface RIS, the transmitter Tx may combine the data frames DATA into one multiple access data frame MADATA. For example, the transmitter Tx may spatially combine the data frames DATA to be transmitted to the access receivers into the one multiple access data frame MADATA. The transmitter Tx may transmit the combined one multiple access data frame MADATA to the reconfigurable intelligent surface RIS. In this case, each of the data frames DATA spatially combined into the one multiple access data frame MADATA may be transmitted to a corresponding reflective element among the plurality of reflective elements of the reconfigurable intelligent surface RIS. Specifically, each of the data frames DATA spatially combined into the one multiple access data frame MADATA may be transmitted to the corresponding reflective element in a spatially different path. As the transmitter Tx transmits the one multiple access data frame MADATA to the reconfigurable intelligent surface RIS, data frames DATA may be transmitted simultaneously to the reconfigurable intelligent surface RIS.

Also, when the reconfigurable intelligent surface RIS transmits the data frames DATA simultaneously to each of the access receivers, the reconfigurable intelligent surface RIS may separate the one multiple access data frame MADATA received from the transmitter Tx into the data frames DATA. For example, the reconfigurable intelligent surface RIS may separate (e.g., spatially separate or spatially divide) the one multiple access data frame MADATA into the data frames DATA again. The reconfigurable intelligent surface RIS may transmit the separated data frames DATA simultaneously to the access receivers. In this case, each of the spatially separated data frames DATA may be transmitted to a corresponding receiver among the access receivers based on the corresponding reflective element among the plurality of reflective elements of the reconfigurable intelligent surface RIS. Specifically, each of the spatially separated data frames DATA may be transmitted simultaneously to the corresponding receiver through the spatially different path.

As described above, the wireless network system 100 according to an embodiment of the present disclosure spatially combines the data frames DATA into the one multiple access data frame MADATA, and spatially separates the combined one multiple access data frame MADATA into the data frames DATA, so that a data transmission rate may be improved. Specifically, the wireless communications system 100 according to the embodiment of the present disclosure may provide the improved data transmission rate as a time required for data transmission is shorter by using the spatial division method in which the data frames DATA are spatially separated and transmitted simultaneously to each of the access receivers than by using a time division method in which data frames DATA are temporally separated and transmitted to each of the access receivers.

In the wireless network system 100 according to the embodiment of the present disclosure, the RTS frame rRTS and the CTS frame rCTS may include a field (e.g., a Duration field) related to information of time required for communication between the transmitter Tx and each of the plurality of receivers Rx1 to Rxn. Therefore, each of the non-access receivers may set the NAV based on the field related to the information of time included in the RTS frame rRTS and the CTS frame rCTS. The non-access receivers may not access to the wireless channel while communication between the transmitter Tx and each of the access receivers is performed, based on the set NAV. Specifically, the information of time required for the communication between the transmitter Tx and each of the plurality of receivers Rx1 to Rxn may include information of time required for the reconfigurable intelligent surface RIS to relay the communication between the transmitter Tx and each of the plurality of receivers Rx1 to Rxn. A description of the field related to such information of time will be described below with reference to FIGS. 7A and 7B.

In addition, in the wireless network system 100 according to the embodiment of the present disclosure, the RTS frame rRTS may include a field related to the number of the plurality of reflective elements of the reconfigurable intelligent surface RIS. Therefore, the plurality of receivers Rx1 to Rxn that received the RTS frame rRTS from the transmitter Tx may predict the time required for exchanging the RTS frame rRTS and the CTS frame rCTS based on the field related to the number of the plurality of the reflective elements included in the RTS frame rRTS.

In addition, in the wireless network system 100 according to the embodiment of the present disclosure, the CTS frame rCTS may include a field related to the number of antennas of each of the access receivers. Therefore, the transmitter Tx may improve data transmission efficiency based on the field related to the number of the plurality of reflective elements included in the RTS frame rRTS and the field related to the number of the antennas of each of the access receivers included in the CTS frame rCTS. For example, when the number of recruited nodes is insufficient in consideration of the number of reflective elements, the transmitter T x may transmit the plurality of data frames DATA simultaneously to the receiver having the plurality of antennas, thereby providing the improved data transmission efficiency.

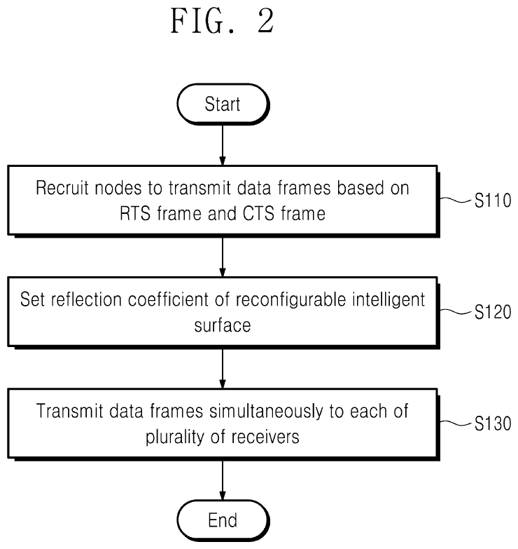

FIG. 2 is a flowchart illustrating an example of an operating method of a wireless network system 100 according to an embodiment of the present disclosure. Referring to FIGS. 1 and 2, in operation S110, the wireless network system 100 may recruit the nodes to transmit the data frames DATA based on the RTS frame rRTS and the CTS frame rCTS. For example, the transmitter Tx and each of the plurality of receivers Rx1 to Rxn may exchange the RTS frame IRTS and the CTS frame rCTS to recruit the nodes to be accessed to the wireless channel. Specifically, in response to the RTS frame rRTS received from the transmitter Tx, the access receivers may transmit the CTS frame rCTS to the transmitter Tx.

In operation S120, the wireless network system 100 may set the reflection coefficient of the reconfigurable intelligent surface RIS. For example, the controller CON may control the reflection coefficient of the reconfigurable intelligent surface RIS, so that the reconfigurable intelligent surface RIS may set the reflection coefficient.

In operation S130, the wireless network system 100 may transmit the data frames DATA simultaneously to each of the plurality of receivers Rx1 to Rxn. For example, the transmitter Tx may transmit the data frames DATA through the reconfigurable intelligent surface RIS simultaneously to each of the nodes recruited in the operation S110 (e.g., the recruited access receivers).

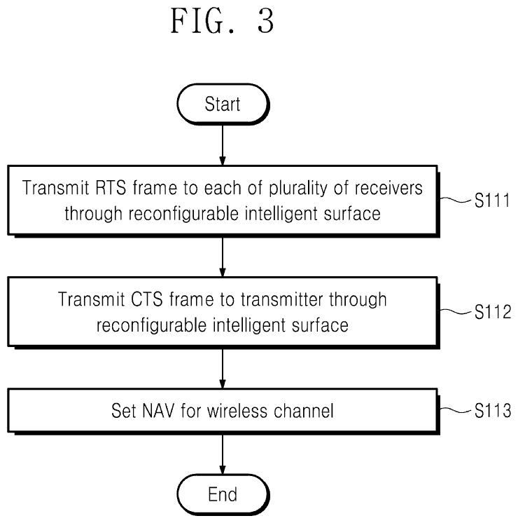

FIG. 3 is a flowchart illustrating an example of a method for recruiting nodes to transmit a data frames DATA by a wireless network system 100 according to an embodiment of the present disclosure. Referring to FIGS. 1, 2, and 3, in operation S111, the wireless network system 100 may transmit the RTS frame IRTS to each of a plurality of receivers Rx1 to Rxn through the reconfigurable intelligent surface RIS. For example, the transmitter Tx may transmit the RTS frame rRTS to each of the plurality of receivers Rx1 to Rxn through the reconfigurable intelligent surface RIS.

In operation S112, the wireless network system 100 may transmit the CTS frame rCTS to the transmitter Tx through the reconfigurable intelligent surface RIS. For example, each of the access receivers may transmit the CTS frame rCTS to the transmitter Tx through the reconfigurable intelligent surface RIS.

In operation S113, the wireless network system 100 may set the NAV for the wireless channel. For example, each of the non-access receivers may set the NAV for the wireless channel based on the RTS frame rRTS and the CTS frame rCTS exchanged in operation S111 and operation S112.

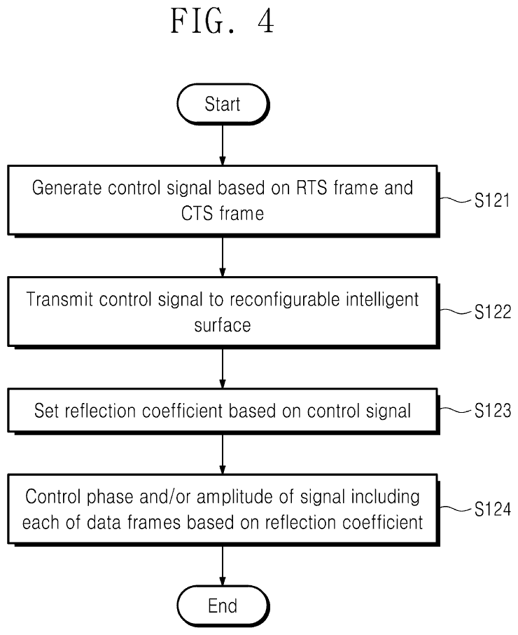

FIG. 4 is a flowchart illustrating an example of a method for setting a reflection coefficient of a reconfigurable intelligent surface RIS by a wireless network system 100 according to an embodiment of the present disclosure. Referring to FIGS. 1, 2, 3, and 4, in operation S121, the wireless network system 100 may generate the control signal CTRL based on the RTS frame rRTS and the CTS frame rCTS. For example, the controller CON may generate the control signal CTRL, based on the RTS frame rRTS and the CTS frame rCTS exchanged in operation S111 and operation S112.

In operation S122, the wireless network system 100 may transmit the control signal CTRL to the reconfigurable intelligent surface RIS. For example, the controller CON may transmit the generated control signal CTRL to the reconfigurable intelligent surface RIS.

In operation S123, the wireless network system 100 may set the reflection coefficient of the reconfigurable intelligent surface RIS based on the control signal CTRL. For example, the reconfigurable intelligent surface RIS may set the reflection coefficient based on the control signals CTRL received from the controller CON.

In operation S124, the wireless network system 100 may control the phase and/or the amplitude of the signal including each of the data frames DATA based on the reflection coefficient. For example, each of the plurality of reflective elements of the reconfigurable intelligent surface RIS may control the phase and/or the amplitude of the signal including each of the data frames DATA to be transmitted to the access receivers based on the set reflection coefficient.

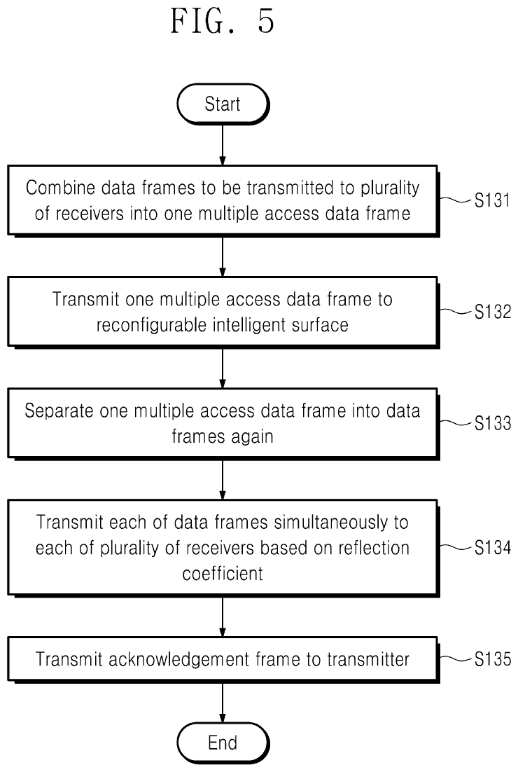

FIG. 5 is a flowchart illustrating an example of a method of simultaneously transmitting a data frames DATA by a wireless network system 100 according to an embodiment of the present disclosure. Referring to FIGS. 1, 2, 3, 4, and 5, in operation S131, the wireless network system 100 may combine the data frames DATA to be transmitted to the plurality of receivers Rx1 to Rxn into the one multiple access data frame MADATA. For example, the transmitter Tx may spatially combine the data frames DATA to be transmitted to each of the access receivers into the one multiple access data frame MADATA.

In operation S132, the wireless network system 100 may transmit the one multiple access data frame MADATA to the reconfigurable intelligent surface RIS. For example, the transmitter Tx may transmit the spatially combined one multiple access data frame MADATA to the reconfigurable intelligent surface RIS.

In operation S133, the wireless network system 100 may separate the one multiple access data frame MADATA into data frames DATA again. For example, the reconfigurable intelligent surface RIS may spatially separate (e.g., spatially divide) one received multiple access data frame MADATA into data frames DATA again.

In operation S134, the wireless network system 100 may transmit each of the data frames DATA simultaneously to each of the plurality of receivers Rx1 to Rxn based on the reflection coefficient. For example, the reconfigurable intelligent surface RIS may transmit each of the data frames DATA to each of the access receivers based on the reflection coefficient set in operation S123.

In operation S135, the wireless network system 100 may transmit the acknowledgement frame ACK to the transmitter Tx. For example, each of the access receivers may transmit the acknowledgement frame ACK through the reconfigurable intelligent surface RIS in response to each of the data frames DATA received in operation S134.

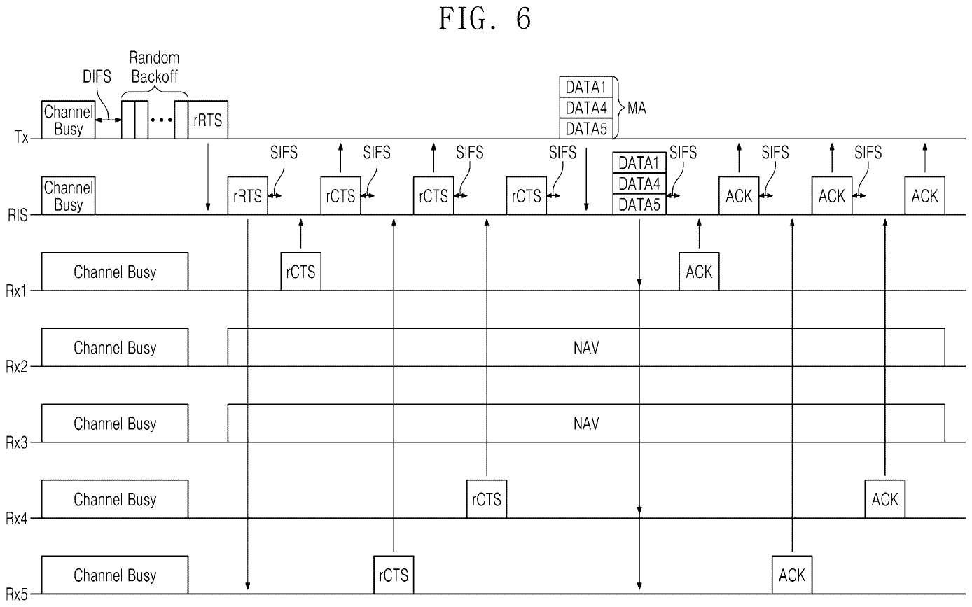

FIG. 6 is a diagram illustrating a communication process of a wireless network system 100 according to an embodiment of the present disclosure. Referring to FIGS. 1 and 6, the wireless network system 100 may include the transmitter Tx, the reconfigurable intelligent surface RIS, and the plurality of receivers Rx1 to Rxn. In FIG. 6, it is described that the wireless network system 100 includes first to fifth receivers Rx1 to Rx5, the first, fourth, and fifth receivers RX1, Rx4, and Rx5 among the first to fifth receivers Rx1 to Rx5 are the access receivers having the data frames DATA to be received from the transmitter Tx through the wireless channel, and the second and third receivers Rx2 and Rx3 are the non-access receivers having no data frames DATA, but this is an example, and the present disclosure is not limited thereto.

The transmitter Tx may detect whether the wireless channel is in use. When the wireless channel is used, the transmitter Tx may wait without accessing to the wireless channel. When the wireless channels are not in use (e.g., the wireless channels are empty), the transmitter Tx may wait for a Distributed Interframe Space (DIFS) time. If the wireless channel is still empty while the transmitter Tx waits for the DIFS time, the transmitter Tx may access to the wireless channel through a random backoff process and transmit the RTS frame rRTS to each of the first to fifth receivers Rx1 to Rx5. For example, in the random backoff process, the transmitter Tx may reduce a backoff counter and when the backoff counter becomes 0, the transmitter Tx may access to the wireless channel and transmit the RTS frame rRTS to each of the first to fifth receivers Rx1 to Rx5 through the reconfigurable intelligent surface RIS. The reconfigurable intelligent surface RIS may transmit the RTS frame rRTS received from the transmitter Tx to each of the first to fifth receivers Rx1 to Rx5.

Each of the first to fifth receivers Rx1 to Rx5 may transmit the CTS frame rCTS to the transmitter Tx in response to the received RTS frame rRTS. For example, each of the first, fourth, and fifth receivers Rx1, Rx4, and Rx5 may transmit the CTS frame rCTS to the transmitter Tx through the reconfigurable intelligent surface RIS within a time defined in the received RTS frame rRTS. The reconfigurable intelligent surface RIS may transmit the CTS frame rCTS received from each of the first, fourth, and fifth receivers Rx1, Rx4, and Rx5 to the transmitter Tx.

Each of the second and third receivers Rx2 and Rx3 may set the NAV based on the field related to the information of time included in the received RTS frame rRTS and the CTS frame rCTS transmitted to the transmitter Tx by each of the first, fourth, and fifth receivers Rx1, Rx4, and Rx5. Each of the second and third receivers RX2 and Rx3, which set the NAV, may not access to the wireless channel while communication between the transmitter Tx and each of the first, fourth, and fifth receivers Rx1, Rx4, and Rx5 is performed.

The transmitter Tx may spatially combine the first, fourth, and fifth data frames DATA1, DATA4, and DATA5 to be transmitted to each of the first, fourth, and fifth receivers Rx1, Rx4, and Rx5 that transmitted the CTS frame rCTS into the one multiple access data frame MADATA. The transmitter Tx may transmit the one multiple access data frame MADATA to the reconfigurable intelligent surface RIS.

The reconfigurable intelligent surface RIS may spatially separate (e.g., spatially divide) the one multiple access data frame MADATA received from the transmitter Tx into first, fourth, and fifth data frames DATA1, DATA4, and DATA5, and may transmit the first, fourth, and fifth data frames DATA1, DATA4, and DATA5 simultaneously to each of the first, fourth, and fifth receivers Rx1, Rx4, and Rx5.

Each of the first, fourth, and fifth receivers Rx1, Rx4, and Rx5 may transmit the acknowledgement frame ACK to the transmitter Tx through the reconfigurable intelligent surface RIS in response to each of the received first, fourth, and fifth data frames DATA1, DATA4, and DATA5.

FIGS. 7A and 7B are diagrams illustrating an RTS frame rRTS and a CTS frame rCTS of a wireless network system 100 according to an embodiment of the present disclosure. Referring to FIG. 7A, the RTS frame rRTS may include a frame control field, a duration field, a receiver address (RA) field, a transmitter address (TA) field, a number of reflective elements (# of RIS Element) field, and a frame check sequence (FCS) field. According to FIG. 7B, the CTS frame rCTS may include a frame control field, a duration, a receiver address (RA) field, a number of antennas (# of Rx Ant) field, and an FCS field.

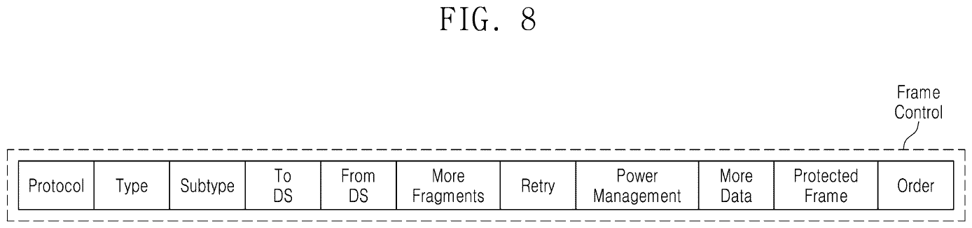

Referring to FIGS. 1, 7A, and 7B, in each of the RTS frame IRTS and the CTS frame rCTS, the frame control field may be a field indicating a type of the corresponding frame. A detailed description of the frame control field will be described below with reference to FIG. 8.

In each of the RTS frame rRTS and the CTS frame rCTS, the duration field may be a basis for each of the access receivers to set the NAV for the wireless channel. That is, the duration field of each of the RTS frame rRTS and CTS frames rCTS may include information of time required for communication between the transmitter Tx and each of the plurality of receivers Rx1 to Rxn. Specifically, the duration field of each of the RTS frame rRTS and the CTS frame rCTS may include information of time required for the reconfigurable intelligent surface RIS to relay communication between the transmitter Tx and each of the plurality of receivers Rx1 to Rxn. For example, a value input to the duration field of the rRTS frame may be calculated based on Equation 1 below, and a value input to the duration field of the CTS frame may be calculated based on Equation 2 below.

$$\begin{matrix}RTS Duration = dRTS + d C T S + d D A T A + d A C K \\ dRTS = tR T S + SIFS \\ dCTS = tC T S + ( t C T S + SIFS ) \\ dDATA = tD A T A + ( t D A T A + SIFS ) \\ dACK = tA C K + t ACK\end{matrix} \qquad [ Equation 1 ]$$

$$\begin{matrix}CTS Duration = dCTS + d D A T A + d A C K \\ dCTA = tC T S + ( t C T S + SIFS ) \\ dDATA = tD A T A + ( t D A T A + SIFS ) \\ dACK = tA C K + t A C K\end{matrix} \qquad [ Equation 2 ]$$

In Equations 1 and 2, the RTS Duration is the value input to the duration field of the RTS frame rRTS, the CTS Duration is the value input to the duration field of the CTS frame rCTS, the tRTS is a time required for transmitting the RTS frame rRTS from the transmitter Tx to the reconfigurable intelligent surface RIS or from the reconfigurable intelligent surface RIS to each of the plurality of receivers Rx1 to Rxn, the tCTS is a time required for transmitting the CTS frame rCTS from each of the plurality the receivers Rx1 to Rxn to the reconfigurable intelligent surface RIS, or from the reconfigurable intelligent surface RIS to the transmitter Tx, the tDATA is a time required for transmitting the data frames DATA from the transmitter Tx to the reconfigurable intelligent surface RIS or from the reconfigurable intelligent surface RIS to each of the plurality of receivers Rx1 to Rxn, the tACK is a time required for transmitting the acknowledgement frame ACK from each of the plurality of receivers RX1 to Rxn to the reconfigurable intelligent surface RIS or from the reconfigurable intelligent surface RIS to the transmitter Tx, and the Short Interframe Space (SIFS) is a waiting time used before transmitting the CTS frame or the acknowledgement frame ACK.

In Equations 1 and 2, it is illustratively described that the time required for transmitting each of the RTS frame rRTS and the data frames DATA from the transmitter Tx to the reconfigurable intelligent surface RIS is equal to the time required for transmitting from the reconfigurable intelligent surface RIS to each of the plurality of receivers Rx1 to Rxn, and the time required for transmitting each of the CTS frame rCTS and the acknowledgement frame ACK from each of the plurality of receivers Rx1 to Rxn to the reconfigurable intelligent surface RIS is equal to the time required for transmitting from the reconfigurable intelligent surface RIS to the transmitter Tx, but this is an example, and the present invention is not limited thereto.

Thus, even for the same frame, the time required for transmitting each of the frames may be different according to the path through which it is transmitted. For example, even for a same frame, if an origin from which the transmission starts or a destination to which the transmission ends is different, the time required for transmitting may be different.

Referring to Equations 1 and 2, the time required for each of the transmitter Tx and the plurality of receivers Rx1 to Rxn to exchange the frames (e.g., RTS frame rRTS, CTS frame rCTS, data frames DATA, and acknowledgement frame ACK) may further include the time required for relaying by the reconfigurable intelligent surface RIS. Therefore, the non-access receivers may set the more accurate NAV based on the value input to the duration field of each of the RTS frame IRTS and the CTS frame rCTS calculated based on Equations 1 and 2. That is, while communication between the transmitter Tx, and each of the access receivers is performed, a reduction of a wireless communication performance due to access attempt or interference of the non-access receivers may be resolved.

The number of reflective elements field in the RTS frame rRTS may be a field indicating the number of the plurality of reflective elements of the reconfigurable intelligent surface RIS. The number of antennas field in the CTS frame rCTS may be a field indicating the number of antennas of each of the plurality of receivers Rx1 to Rxn. As described above with reference to FIG. 1, each of the plurality of receivers Rx1 to Rxn may predict the time required for exchanging the RTS frame rRTS and the CTS frame rCTS based on the number of reflective elements field of the received RTS frame rRTS. In addition, as described above with reference to FIG. 1, the transmitter Tx may improve the data transmission efficiency based on the number of reflective elements field of the RTS frame rRTS and the number of antennas field of the CTS frame rCTS.

In the RTS frame rRTS, the receiver address field may be a field indicating a physical address (e.g., a MAC address) of the receiver to receive data. In the CTS frame rCTS, the receiver address field may be a field indicating a physical address (e.g., a MAC address) of the receiver to receive data. In the RTS Frame rRTS, the transmitter address field may be a field indicating a physical address of the transmitters Tx that transmit data. In each of the RTS frame rRTS and the CTS frame rCTS, the frame check sequence field may be a field for checking whether the data is corrupted during transmission of the corresponding frames.

FIG. 8 is a diagram illustrating a frame control field included in the RTS frame IRTS and the CTS frame rCTS of FIGS. 7A and 7B. Referring to FIGS. 1, 7A, 7B, and 8, the frame control field included in each of the RTS frame rRTS and the CTS frame rCTS may include a protocol field, a type field, a subtype field, distributed system directional (To/From DS) fields, an more frame (More Fragments) field, a retransmission (Retry) field, a power management field, an more data field, an encrypted (Protected) field, and an order field as subfields.

Among the subfields included in the frame control field, the subtype field may be a subfield indicating whether each of the RTS frame rRTS and the CTS frame rCTS exchanged by the transmitter Tx and each of the plurality of receivers Rx1 to Rxn is exchanged through the reconfigurable intelligent surface RIS. That is, as described above with reference to FIG. 1, the transmitter Tx and each of the receivers Rx1 to Rxn exchanging the RTS frame rRTS and the CTS frame rCTS may determine whether the corresponding frame is the frame relayed by the reconfigurable intelligent surface RIS based on the subtype field.

For example, at least one bit may be added to the subtype field compared to the subtype field of a conventional RTS frame rRTS and a conventional CTS frame rCTS. Specifically, based on a value input to the subtype filed to which at least one bit is added, the transmitter Tx and the plurality of receivers Rx1 to Rxn may determine whether the corresponding frame is the frame received by relaying of a reconfigurable intelligent surface RIS.

The protocol field may be the subfield indicating a version of the IEEE 802.11 protocol. The type field may be the subfield indicating the type of the corresponding frame. The distributed system directional field may be the subfield indicating whether the corresponding frame is transmitted to the distributed system, whether the corresponding frame is received from the distributed system, or whether the corresponding frame is unrelated to the distributed system. The more frame field may be the subfield indicating whether the corresponding frame is segmented (e.g., divided) so that additional segments exist. The retransmission field may be the subfield indicating whether the corresponding frame corresponds to a retransmission of a previously transmitted frame. The power management field may be the subfield indicating a power mode (e.g., power saving mode, active mode, etc.) of the transmitter Tx. The more data field may be the subfield indicating whether additional data is to be transmitted later. The encryption field may be the subfield indicating whether the corresponding frame is encrypted. The order field may be the subfield indicating a frame order of the corresponding frame.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A wireless network system comprising:
a transmitter;
a plurality of receivers; and
a reconfigurable intelligent surface configured to relay communication between the transmitter and the plurality of receivers,
wherein the transmitter transmits an RTS frame to each of the plurality of receivers through the reconfigurable intelligent surface,
wherein at least two receivers of the plurality of receivers respectively transmit a CTS frame to the transmitter through the reconfigurable intelligent surface in response to the RTS frame, and
wherein the transmitter is configured to transmit a plurality of data frames simultaneously to the at least two receivers that transmitted the CTS frame, respectively, through the reconfigurable intelligent surface.

2. The wireless network system of claim 1, wherein each of the RTS frame and the CTS frame comprises a field related to information of time required for the reconfigurable intelligent surface to relay communication between the transmitter and the plurality of receivers.

3. The wireless network system of claim 2, wherein when there is at least one receiver of the plurality of receivers that did not transmit a CTS frame to the transmitter through the reconfigurable intelligent surface in response to the RTS frame, the at least one receiver is configured to set a NAV based on the field related to the information of the time.

4. The wireless network system of claim 1, wherein the transmitter is configured to combine the plurality of data frames to be transmitted simultaneously to the at least two receivers into one multiple access frame.

5. The wireless network system of claim 4, wherein the transmitter is configured to transmit the one multiple access frame to the reconfigurable intelligent surface.

6. The wireless network system of claim 5, wherein the reconfigurable intelligent surface is configured to separate the received one multiple access frame into the plurality of data frames.

7. The wireless network system of claim 6, further comprising a controller configured to control a reflection coefficient of the reconfigurable intelligent surface,
wherein the controller is configured to:
receive the RTS frame from the transmitter; and
receive the CTS frame from each of the at least two receivers;
generate a control signal based on the received RTS frame and the received CTS frame; and
transmit the control signal to the reconfigurable intelligent surface.

8. The wireless network system of claim 7, wherein the reconfigurable intelligent surface is configured to:
set the reflection coefficient based on the control signal; and
transmit the plurality of data frames simultaneously to the at least two receivers, respectively, based on the reflection coefficient.

9. An operating method of a wireless network system, the operating method comprising:
transmitting, by a transmitter, an RTS frame to each of a plurality of receivers through a reconfigurable intelligent surface;
respectively transmitting, by at least two receivers of the plurality of receivers, a CTS frame to the transmitter through the reconfigurable intelligent surface in response to the RTS frame; and
transmitting, by the transmitter, a plurality of data frames simultaneously to the at least two receivers that transmitted the CTS frame, respectively.

10. The operating method of claim 9, further comprising setting, by at least one receiver that did not transmit a CTS frame to the transmitter, a NAV based on a field related to information of time required for communication through the reconfigurable intelligent surface between the transmitter and the plurality of receivers, the field included in the RTS frame and the CTS frame.

11. The operating method of claim 9, wherein the transmitting the plurality of data frames simultaneously comprises:
combining, by the transmitter, the plurality of data frames to be respectively transmitted to the at least two receivers into one multiple access frame; and
transmitting, by the transmitter, the one multiple access frame to the reconfigurable intelligent surface.

12. The operating method of claim 11, wherein the transmitting the plurality of data frames simultaneously further comprises:
separating, by the reconfigurable intelligent surface, the one multiple access frame into the plurality of data frames; and
transmitting, by the reconfigurable intelligent surface, the plurality of data frames simultaneously to the at least two receivers, respectively.

13. The operating method of claim 12, further comprising:
receiving, by a controller, the RTS frame from the transmitter;
receiving, by the controller, the CTS frame from each of the at least two receivers;
generating, by the controller, a control signal based on the RTS frame and the CTS frame; and
transmitting, by the controller, the control signal to the reconfigurable intelligent surface.

14. The operating method of claim 13, further comprising setting, by the reconfigurable intelligent surface, a reflection coefficient based on the control signal.

15. The operating method of claim 14, wherein the transmitting, by the reconfigurable intelligent surface, the plurality of data frames simultaneously to the at least two receivers, respectively, further comprises:
transmitting, by the reconfigurable intelligent surface, the plurality of data frames simultaneously to the at least two receivers, respectively, based on the reflection coefficient.

16. A high frequency wireless local area network system, comprising:
a transmitter;
a plurality of receivers;
a reconfigurable intelligent surface configured to relay communication between the transmitter and the plurality of receivers; and
a controller configured to control a reflection coefficient of the reconfigurable intelligent surface,
wherein the plurality of receivers respectively transmit a CTS frame to the transmitter through the reconfigurable intelligent surface in response to an RTS frame that the transmitter transmits to each of the plurality of receivers through the reconfigurable intelligent surface,
wherein the controller generates a control signal based on the RTS frame received from the transmitter and the CTS frame transmitted by the plurality of receivers in response to the RTS frame, and transmits the generated control signal to the reconfigurable intelligent surface,
wherein the transmitter combines a plurality of data frames to be respectively transmitted to the plurality of receivers that transmitted the CTS frame through the reconfigurable intelligent surface into one multiple access frame, and transmits the one multiple access frame to the reconfigurable intelligent surface, and
wherein the reconfigurable intelligent surface is configured to separate the one multiple access frame into the plurality of data frames, set the reflection coefficient based on the control signal, and transmit the plurality of data frames to the plurality of receivers that transmitted the CTS frame, respectively, based on the reflection coefficient.
